(19) United States
(12) Patent Application Publication
(10) Pub. No.: US 2022/0073380 A1
(43) Pub. Date: Mar. 10, 2022

(54) FLOW-THROUGH ELECTROCHEMICAL REACTOR

(71) Applicant: ACLARITY, LLC, North Oxford, MA (US)

(72) Inventors: Orren David Schneider, Plainsboro, NJ (US); Julie Bliss Mullen, North Oxford, MA (US); Barrett Mully, Amherst, MA (US)

(21) Appl. No.: 17/470,637

(22) Filed: Sep. 9, 2021

Related U.S. Application Data
(60) Provisional application No. 63/076,240, filed on Sep. 9, 2020.

(51) Int. Cl. C02F 1/467; C02F 1/461

(52) U.S. Cl. CPC C02F 1/4676; C02F 2001/46171; C02F 2001/46133; C02F 1/46109

(57) ABSTRACT

A flow-through electrochemical reactor includes a housing having a solution flow-path. A flow-through or solid first electrode is disposed within the solution flow path. A second electrode is spaced apart from the flow-through or solid first electrode, thereby creating an electroactive gap between the flow-through or solid first electrode and the second electrode. The electroactive gap is less than 5 mm and greater than 2 mm.

### FIELD OF THE DISCLOSURE

The disclosure relates to liquid purification devices and more specifically to a flow-through electrochemical reactor for purifying water.

### BACKGROUND

With increasing occurrence of various microorganisms and anthropogenic pollutants in the environment, access to clean drinking water is a growing concern around the world. The quality of water available for potable use varies greatly depending on the source and active treatment processes. Varying characteristics of source waters make treatment processes difficult to control, let alone standardize. For example, various contaminants found in source waters have a range of differing properties, which dictate the type of treatment process used for removal (i.e., physical or chemical). As a result, the majority of commercialized water treatment systems do not have the physical and/or chemical capabilities to treat different water sources because of their limited treatment capacities implemented for their specific source water. In attempting to address these issues in home treatment systems, recent technologies have emerged involving the combination of membrane technology with advanced oxidation processes that produce hydroxyl radicals to cause degradation of contaminants present in the treated water. Most known water purification devices, however, require large amounts of energy per quantity of water purified and/or are prone to clogging.

### SUMMARY OF THE DISCLOSURE

According to some examples, a flow-through electrochemical reactor includes a housing having a solution flow-path. A flow-through or solid first electrode is disposed within the solution flow path. A second electrode is spaced apart from the flow-through or solid first electrode, thereby creating an electroactive gap between the flow-through or solid first electrode and the second electrode. The electroactive gap is less than 5 mm and greater than 2 mm.

The foregoing example of a flow-through electrochemical reactor may further include any one or more of the following optional features, structures, and/or forms.

In some optional forms, the flow-through electrochemical reactor may include an electroactive gap of less than about 4 mm and greater than about 2.5 mm.

In other optional forms, the flow-through electrochemical reactor may include an electroactive gap having an average size of about 3 mm.

In other optional forms, the first electrode is an anode having a hollow cylindrical shape.

In other optional forms, the second electrode is a cathode having a hollow cylindrical shape.

In other optional forms, the anode and the cathode are arranged concentrically, the anode being located within a cylindrical wall of the cathode. In other optional forms, the anode and cathode may be reversed, with the cathode and the anode being arranged concentrically and the cathode being located within a cylindrical wall of the anode.

In other optional forms, the cathode may have a cylindrical wall including a plurality of openings and/or the anode may have a cylindrical wall including a plurality of openings.

In other optional forms, the solution flow path extends at least partially within the anode, longitudinally along an anode longitudinal axis, and at least partially radially outward, through a wall of the anode, substantially perpendicular to the anode longitudinal axis.

In other optional forms, the solution flow path extends radially, through a wall of the anode, radially across the electroactive gap, and radially through the plurality of openings in the cathode wall.

In other optional forms, the flow-through electrochemical reactor may include an electrolyte solution in the solution flow path.

In other optional forms, the flow-through electrochemical reactor may include a power source connected to the anode and to the cathode.

In other optional forms, the flow-through electrochemical reactor may include an inlet cap at a first end of the housing, the inlet cap relative spacing and alignment of the anode relative to the cathode.

In other optional forms, the flow-through electrochemical reactor may include an outlet guide flow cap at a second end of the housing, the outlet guide flow cap sealing the second end of the housing and receiving outlet flow from the exterior of the cathode, the outlet guide flow cap also sealing one end of the hollow anode.

In other optional forms, the flow-through electrochemical reactor may include an adapter base inlet disposed at a first end of the housing, the adapter base providing plumbing and electrical connections while maintaining a pressure seal.

In other optional forms, the cathode may comprise: stainless steel (or other iron based alloy); graphite, or other carbonaceous materials; dimensionally stable anodes (DSA); Magneli-phase titanium oxide (of general formula TiₙO₂ₙ₋₁); mixed metal oxides, (such as, TiO₂, RuO₂, IrO₂, SnO); boron doped diamond (BDD); or a combination thereof.

In other optional forms, the anode may comprise dimensionally stable anodes (DSA), Magneli-phase titanium oxide (of general formula TiₙO₂ₙ₋₁), mixed metal oxides (such as, TiO₂, RuO₂, IrO₂, SnO), boron doped diamond (BDD), or a combination thereof.

According to another embodiment, a method of electrochemically treating a solution includes positioning an anode and a cathode less than 5 mm and greater than 2 mm apart, thereby creating an electroactive gap between the anode and the cathode; applying power to the anode and to the cathode; and passing a solution containing contaminants through the electroactive gap, electrons passing across the electroactive gap between the cathode and the anode, thereby electrochemically treating the contaminants in the solution.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is an exploded perspective view of a flow-through electrochemical reactor according to the accompanying disclosure.

FIG. 2 is a side view of the flow-through electrochemical reactor of FIG. 1.

FIG. 3 is side cross-sectional view of the flow-through electrochemical reactor of FIG. 1.

FIG. 4 is a close-up side cross-sectional view of an inlet cap of the flow-through electrochemical reactor of FIG. 1

FIG. 5 is a close-up side cross-sectional view of an outlet cap of the flow-through electrochemical reactor of FIG. 1.

### DETAILED DESCRIPTION

The flow-through electrochemical reactors described herein are advantageously used for treatment of water including, but not limited to producing potable water, treating municipal or domestic wastewater, and/or treating industrial wastewater. The flow-through electrochemical reactors described herein are durable and scalable to meet relatively small personal or domestic demands as well as relatively large consumer, commercial, municipal or industrial demands. Advantageously, the flow-through electrochemical reactors described herein have no moving parts and therefore have long useful lives, while being relatively inexpensive and easy to manufacture. Moreover, the flow-through electrochemical reactors described herein surprisingly and unexpectedly can more efficiently treat contaminants present in the water/solution being treated, with significantly less clogging and short-circuiting compared to previous devices, as explained in more detail herein.

As used herein, a flow-through electrochemical reactor refers to a reactor having a solution flow-path there through. The basic structural elements of a flow-through reactor include a housing having an inlet, an outlet, anodes, and cathodes, as described and shown for example in US Patent Publication No. 2019/0284066, which is hereby incorporated by reference in its entirety. Flow-through electrochemical reactors are known to be susceptible to fouling and short circuiting because of solids agglomerating in the electroactive gap. As a result, most electrochemical systems utilize relatively larger electrode gaps (at least 5 mm or greater) and/or are constructed and arranged as static (non-flowing) systems to limit fouling risk. The flow-through electrochemical reactors described herein have electrode gaps of less than 5 mm, but greater than 2 mm. In other embodiments, the flow-through electrochemical reactor may include an electroactive gap of less than about 4 mm and greater than about 2.5 mm, preferably about 3 mm. The aforementioned electrode gap ranges have surprisingly and unexpectedly proved to deliver a very high level of electrochemical efficiency without becoming clogged and potentially short circuiting, as described herein. Thus, the electroactive gaps disclosed herein surprisingly allow a flow-through electrochemical reactor to more efficiently treat contaminants, while advantageously demonstrating improved electrical efficiency without significant fouling. Furthermore, the electroactive gap of less than 5 mm advantageously produces a desirable mix of reactive oxidants. For example, the electrochemical reactions according to the disclosure advantageously produce a higher concentration of hydroxyl radicals, which leads to more efficient water treatment.

The disclosed flow-through electrochemical reactors can be advantageously used to purify various types of water including waste water (e.g., domestic waste water, commercial waste water, municipal waste water, industrial waste water), rain water, lake water, river water, ground water, for multiple end uses, and most significantly, to purify water intended for drinking.

The disclosed flow-through electrochemical reactors utilize electricity to effect water purification. Specifically, oxidants and disinfectants including but not limited to hydroxyl radicals, free chlorine, and ozone are produced on or near the anode surface, which can destroy contaminants such as pathogens and other unwanted organic and inorganic materials (collectively referred to as “contaminants” herein). Contaminants such as nitrates and metal ions can also be reduced on the cathode surface, thereby transforming these unwanted contaminants to less harmful compounds, without added chemicals. Thus, the disclosed flow-through electrochemical reactors may be used to treat water with complex water chemistry, for example, by neutralizing acidic and basic contaminants, oxidizing other contaminants, and removing still other contaminants by reduction. Further, the electrodes employed are not consumed by the reactions, which drastically reduces the maintenance requirements and as well as the cost of replacement. As a result, fouling or scaling of the electrodes by agglomeration of organic matter, or by precipitation of metals, can advantageously be reversed by reversing the polarity of the electrodes, backwashing with water, adding sodium chloride to feed water and increasing voltage, or by cleaning with a mild acid or base.

During water treatment with the disclosed flow-through electrochemical reactors, water is oxidized to form secondary reactive oxygen species (ROS) such as hydroxyl radicals and ozone. The oxidants react quickly with most organic matter that is present in the water/solution being treated, thereby forming carbon dioxide and less harmful byproducts. In addition, direct destruction of contaminants occurs when electrons are transferred from the contaminant to the anode. Perfluorinated compounds such as perfluorooctanoic acid (PFOA) and perfluorooctanesulfonic acid (PFOS) are representative contaminants that can be oxidized using the flow-through electrochemical reactors according to the disclosure. Free chlorine may also be formed in situ from any ambient chloride ions present in the solution to be treated, or from added metal chloride, such as sodium chloride (NaCl), and thus provide another disinfectant. In addition to powerful oxidation and disinfection capabilities, the cathode produces reductants that can reduce unwanted contaminants, thereby causing them to degrade and/or to form less harmful compounds. The combination of oxidant formation, indirect secondary oxidation, direct electron transfer and reduction processes are capable of purifying water including numerous types of contaminants including but not limited to ammonia, nitrite, nitrate, perfluorinated compounds, natural and synthetic organic compound, and pathogens. The electrode gaps disclosed herein between 2 mm and 5 mm advantageously produce higher concentrations of oxidant species for a given power input (at least relative to conventional flow-through electrochemical reactors), thereby more efficiently reducing the amounts of organic matter and other contaminants (again, at least relative to conventional flow-through electrochemical reactors).

Changes in pH occurring on the electrode surfaces due to the electrolysis of water can cause changes in the pH of the influent water. Typically, H⁺ is formed at the cathode and OH⁻ is formed at the anode, both at relatively high quantities. Oxidation occurring at the anode can cause the complete or partial mineralization of many organic compounds, resulting in the formation of CO₂. The formed CO₂ is dissolved in the influent water, thereby creating carbonic acid (H₂CO₃), which lowers the pH. pH also may be lowered by the destruction of ammonia. Thus, changes in pH are, at least in part, dependent on the chemistry of the influent water. Further, formation of hydronium and hydroxide species may be sufficiently high that, coupled with the various redox processes mentioned above, pathogens including bacteria, viruses, and protozoa cannot survive.

As discussed above, although not necessary, the solution to be treated may include added metal salts to facilitate electrochemical processes. For example, the solution may include a metal salt, which can provide a source of chloride ions that can be oxidized to form chlorine gas, a powerful oxidant, in situ. Chlorine gas is highly soluble in water and undergoes hydrolysis to form hypochlorous acid (HOCl). Chlorine dioxide (ClO₂) may also be formed in some cases. Salts, such as NaCl, or other salts, may be introduced upstream of the electrochemical reactor and/or may be present in the influent water.

“About,” “approximately,” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one standard deviation, or within ±10%, 5%, 3%, or 1% of the stated value.

“Carbonaceous” as used herein means a material that comprises carbon. To be considered “carbonaceous” as used herein, a material should contain carbon with carbon atoms in other than a +4 oxidation state (such that the carbon atoms are capable of being oxidized). For example, carbonaceous materials include, but are not limited to, graphite, graphene, fullerenes, electrically conductive plastics, and diamond.

“Flow-through” anode or cathode as used herein refers to an anode or cathode electrode through which liquid is capable of flowing. Some non-limiting examples of flow-through electrodes include anodes or cathodes having an inner through path and/or comprising perforations, pores, or holes through which liquid can flow. The holes may be manufactured in the electrode by punching, for example. In one example, a solid but hollow cylindrical electrode may have an inner through path in which liquid can flow axially along a length of the hollow cylindrical electrode. Other non-limiting examples include anodes having a material wall comprising a porous material, for example, a hollow cylindrical anode or cathode having a material wall comprising a porous material through which liquid can flow both axially along the length of the anode or cathode as well as laterally through the cylindrical anode or cathode wall. Porous electrodes, for example, porous Magneli-phase, e.g., Ti₄O₇, anodes, are generally preferred in that they provide high surface area and increased contact with the water/solution to be electrochemically treated (typically, water), which is advantageous for producing relatively increased amounts of oxidants such as hydroxyl radicals and ozone that can react with contaminants within the water/solution being treated as well as causing relatively increased oxidation of the contaminants. Solid plate-type anodes (that are not hollow and do not have an inner flow-through path) may also be used. Thus, both anodes and cathodes may be flow-through or solid.

In order for any electrochemical process to operate, there must be two (or more) electrodes functioning as anodes and cathodes. “Electroactive gap” as used herein means a gap or space between the electrodes functioning as the anode(s) and the cathode(s). In the disclosed flow-through electrochemical reactors, the electroactive gap is included in the flow path through which the solution, typically an aqueous phase to be treated, may flow and electrons may be transferred when the electrodes of the electrochemical reactors are powered. The current flow can cause various chemical reactions to take place within the electroactive gap that cause contaminants in the water/solution being treated to degrade and/or be rendered inactive, thereby purifying the water and converting non-potable water to potable water and/or allowing the effluent stream to be released to the environment.

Because small electroactive gaps (less than about 5 mm) were expected to result in clogging by solids, increased hydraulic resistance (fluid friction), and bridging by salts leading to eventual short-circuiting, it was surprising and unexpected that the disclosed flow electrochemical through reactors more efficiently treat contaminants, while advantageously demonstrating improved electrical efficiency without significant fouling. Increasing the gap above 5 mm resulted in significantly less efficient electrochemical purification of the water/solution to be treated. Decreasing the electroactive gap below 2 mm creates current leakage, fouling and electrical arcing across the electroactive gap. Surprisingly, the speciation of oxidants generated as a result of an electrochemical gap between 2 mm and 5 mm, between about 2.5 mm and about 4 mm, preferably about 3 mm is advantageously enriched in powerful oxidants such as hydroxyl radicals.

It has been determined that a reduction in electrode gap from 5 to 3 mm surprisingly results in a decrease in the resistance of the bulk electrolyte by 14-33%, depending on the conductivity of the solution. Practically speaking, one having ordinary skill in the art would have expected that, at electro-active gaps of less than 5 mm, various chemical reactions will interfere with electrical flow, thereby raising (or at least reducing the decrease of) electrical resistance between the electrodes. Such interference was surprisingly not observed at a significant level, and thus, the reduction of resistance that accompanied the reduction of the electro-active gap to less than 5 mm was surprisingly greater than would otherwise be expected in a practical application. At low total dissolved solids (TDS) concentrations of 10 ppm or less, a reduction in the electro-active gap from 5 to 3 mm corresponds to a decrease in electrolyte resistance of 33%, from 16.7Ω to 11.2Ω. At higher TDS concentrations of 1000 ppm, the same decrease from 5 to 3 mm corresponds to a decrease in electrolyte resistance of 14%, from 3.1Ω to 2.6Ω. TDS may include any ionic solid that dissociates in water. The disclosed electrochemical reactors advantageously use low power, for example, about 5 watts to about 40 watts, preferably about 10 watts, to provide effective water treatment. In other embodiments, higher power may be used, for example in devices used to treat influent aqueous phases known or expected to contain PFAS, up to 12 volts and 50 amps may be used.

Furthermore, a reduction in the electro-active gap from 5 mm to 3 mm surprisingly resulted in an increase of between approximately 47% and 203% for the first order rate constant when removing ammonia, and an increase of 51% to 84% in production of oxidants, as further discussed below. The first order rate constant is an indication of how efficiently the reactor is removing contaminants. The term “first order rate constant,” as used herein, is defined as the constant k described by the following equation,

Cₜ=C₀e^{-kt}

where t is time, Cₜ is the concentration of a substance at time, t, and C₀ is the initial concentration of the substance at time=0. First order rate constants are calculated by applying a linear regression model to a plot of Ln(C₀/Cₜ) versus time.

Generally speaking, a relatively higher first order rate constant (k) means a more efficient reactor for a given contaminant. In other words, the chemical reactions taking place within the reactor causing the contaminant to degrade and/or be rendered inactive are occurring more quickly.

“Dimensionally stable anode” as used herein refers to an anode that displays relatively high conductivity and corrosion resistance. Generally, dimensionally stable anodes are manufactured from one or more metal oxides such as RuO₂ (ruthenium oxide), IrO₂ (iridium oxide), SnO (tin oxide) or PtO₂ (platinum oxide).

“Mixed metal oxide electrodes” (which may be used as the anode or as the cathode) are made by coating a substrate, such as a titanium plate or an expanded mesh, with several metal oxides. One oxide is usually RuO₂ (ruthenium oxide), IrO₂ (iridium oxide), SnO (tin oxide) or PtO₂ (platinum oxide), which conducts electricity and catalyzes the desired reactions such as the production of chlorine gas in situ. The other exterior coatings the metal oxide is typically titanium dioxide which does not significantly conduct or catalyze, but prevents corrosion of the interior.

In some embodiments, an optional pre-filter may be installed upstream of electrodes and/or a post-filter may be added downstream of the electrodes, the pre or post-filter capturing particles or various inorganic or organic materials thereby preventing the particles from creating short circuiting bridges between electrodes, and/or by removing particles formed by the electrochemical reactions.

Turning now to the figures, a flow-through electrochemical reactor 10 includes a housing 12 having a solution flow-path 14. A flow-through or solid first electrode, such as an anode 16, is disposed within the solution flow path 14. In the illustrated embodiment, the anode 16 is annulus-shaped, in some cases a hollow cylinder, comprising a porous material.

A second electrode, such as a cathode 18, is spaced apart from the anode 16, thereby creating an electroactive gap 20 between the anode 16 and the cathode 18. The electroactive gap 20 is less than 5 mm and greater than 2 mm. In the exemplified embodiment, the electroactive gap is about 3 mm. As mentioned above, the concentric arrangement of the anode 16 and the cathode 18 may be reversed.

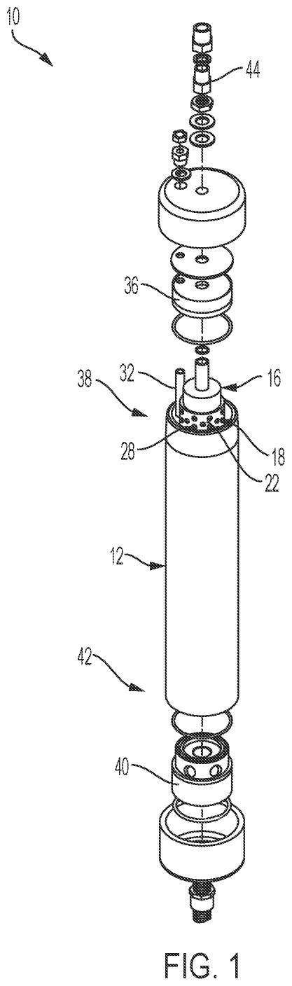

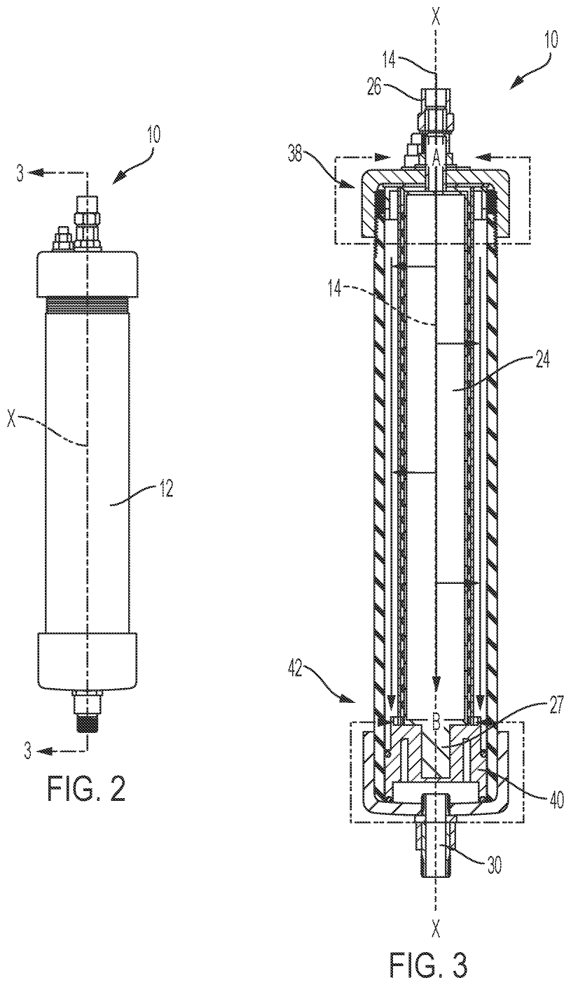

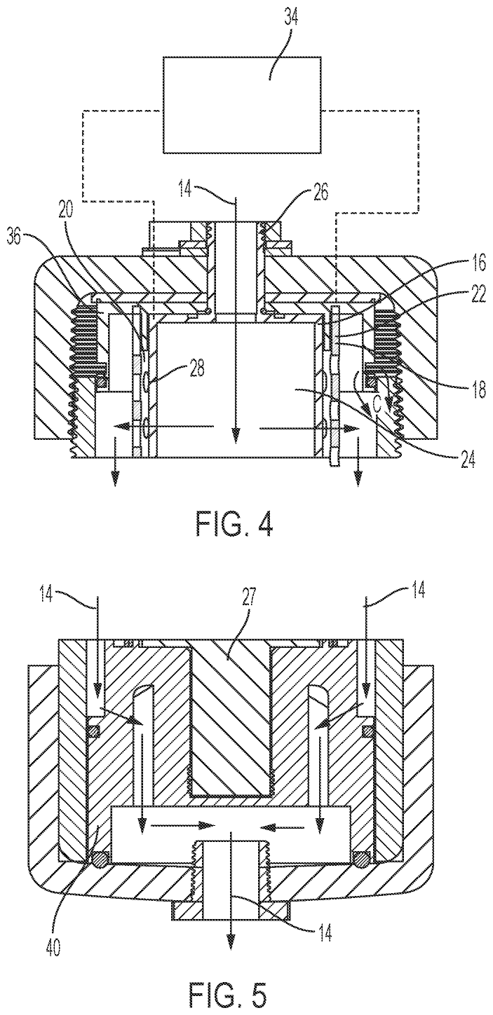

In the illustrated embodiment, both the anode 16 and the cathode 18 have a hollow cylindrical shape. The anode 16 and the cathode 18 are arranged concentrically, the anode 16 being located within a cylindrical wall 22 of the cathode 18. The arrangement illustrated in FIGS. 1-5 may be used as an oxidizing reactor. In other embodiments, for example when used as a reducing reactor, the anode 16 and the cathode 18 may be reversed (such as by reversing electrical connections) so that the cathode 18 may be located within a cylindrical wall of the anode 16. Regardless, the anode 16 and the cathode 18 may share a common longitudinal axis x. An interior 24 of the anode 16 forms an initial flow path for the water/solution to be treated that enters the housing 12 through an inlet 26. As the water/solution to be treated fills the interior 24, it flows longitudinally, parallel to the longitudinal axis x and eventually reaches the bottom of the interior 24 where the liquid is stopped by a plug 27. Once stopped, pressure builds up in the interior 24, which forces the liquid to flow radially outward, perpendicular to the longitudinal axis x, through the wall of the anode 16.

The liquid may pass through the wall of the anode 16 through porous openings in the anode, or through perforations in the anode 16. Regardless, once the liquid flows through the wall of the anode 16, the liquid enters the electroactive gap 20. When in the electroactive gap 20, chemical reactions take place in the liquid, which are driven by the electron flow supplied by the charged anode and cathode. The liquid continues to flow radially outward through the cathode wall 22, for example through a plurality of openings 28 in the cathode wall 22. Once through the cathode wall 22, the liquid flows in the annular space formed between the cathode 18 and the housing 12, towards an outlet 30.

In alternate embodiments, one or both of the anode 16 and the cathode 18 may comprise solid cylindrical walls. In such embodiments, the flow path may enter the hollow interior of the anode 16, flow downward until contracting the plug 27, then around a bottom end of the anode 16, through a gap between a bottom of the anode 16 wall and the plug 27, then upward through the electroactive gap 20 until contacting an inlet cap 36 and through a gap between the inlet cap 36 and the top end of the cathode 18, then downward on the outside of the cathode 18 to the outlet. In other alternate embodiments, the anode 16 or the cathode 18 may comprise solid cylindrical walls and the flow path may flow over the outer surface of the solid cylindrical wall and through the electroactive gap 20.

A power source 34 is connected to the anode 16 and to the cathode 18 via an electrical connection 32. Usually, the power source will be a DC power source. However, an AC power source could alternatively be used. The power source 34 charges the anode 16 and the cathode 18 and water/solution being treated fills the electroactive gap 20, electrons flow between the anode 16 and the cathode 18 and the electricity provided drives certain desirable chemical reactions causing oxidation or reduction of contaminants and inactivation of pathogens.

The inlet cap 36 is disposed at a first end 38 of the housing 12, the inlet cap 36 maintains proper spacing and orientation of the anode 16 relative to the cathode 18. An outlet guide flow cap 40 is disposed at a second end 42 of the housing 12. The outlet guide flow cap 40 seals the second end 42 of the housing 12 and receives outlet flow from the exterior of the cathode 18. The outlet guide flow cap 40 also seals one end of the interior 24 of anode 24 in conjunction with the plug 27.

An adapter base inlet 44 is disposed at the first end 38 of the housing 12, the adapter base inlet 44 providing plumbing and electrical connections while maintaining a pressure seal.

The cathode 18 may comprise stainless steel, graphite, or other carbonaceous materials, dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) or PtO₂ (platinum oxide), or boron doped diamond (BDD), or a combination thereof. As used herein, the term “Magneli-phase titanium oxide” refers to a titanium oxide having general formula TiₙO₂ₙ₋₁, for example, Ti₄O₇, Ti₅O₉, Ti₆O₁₁, or a mixture thereof. In an embodiment, the Magneli-phase titanium oxide may be Ti₄O₇. In other embodiments, the Magneli-phase titanium oxide may be a mixture of Magneli-phase titanium oxides.

The anode 16 may comprise one of dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) or PtO₂ (platinum oxide), boron doped diamond (BDD), others, or a combination thereof.

The anode 16 and/or the cathode 18 may comprise a catalytic coating. The catalytic coating may be between 1 μm and 30 μm thick, preferably between 5 μm and 20 μm, and more preferably between 10 μm and 20 μm. The catalytic coating may comprise a metal chosen from one or more in the group of ruthenium (Ru), rhodium (Rh), palladium (Pd), iridium (Ir), platinum (Pt), and tantalum (Ta). For example, the catalytic combination may comprise a combination of Ru and Ta, a combination of Rh and Ta, a combination of Pd and Ta, a combination of Ir and Ta, a combination of Pt and Ta, a combination of Ru and Ir, a combination of Rh and Ir, a combination of Pd and Ir, or a combination of Pt and Ir.

Once an appropriate flow-through reactor is constructed and arranged, the power is applied to the cathode(s) and the anode(s), and water/solution to be treated is passed through the electrodes resulting in electrochemical purification thereof. The purified water/solution is subsequently removed from the reactor. The applied power may be reversed periodically to prevent passivation of the electrodes and to remove foulants. In this embodiment, the cathode may include a sub-stoichiometric titanium oxide or other electrode material. The reactor may be periodically backwashed to purge built up solids that may have accumulated in the pores or openings of the electrode.

In the illustrated embodiment, during use, power is applied to the cathode and the anode, and the influent water is transferred to the inlet cap end of the reactor and into the tubular path located vertically in the center of the reactor. The influent water exits from the outlet of the tube. Typically, the orientation of the reactor is positioned (and thus rotated 180 degrees relative to the illustrations depicted in the FIGS.) so that the inlet is disposed at the bottom and the outlet is disposed at the top. In such an arrangement, the influent water flows from bottom to top. In other embodiments, the anode and cathode may be reversed, as discussed above.

The flow-through reactor, according to any embodiment, may further optionally include an oxidation-reduction potential sensor, a pH sensor, a chlorine sensor, a conductivity sensor, a flow rate sensor, a pressure sensor, a temperature sensor, one or more contaminant sensors (such as nitrogen, TOC, UV-Vis, etc.), or a combination thereof.

Some advantages for using the disclosed flow-through electrochemical reactors for electrochemical water treatment are high corrosion resistance to acidic and basic solutions, high electrical conductivity, increased mass transfer, and electrochemical stability.

The solution may comprise a solution of a metal chloride, such as sodium chloride, in deionized water, tap water, or source water. The metal chloride may be an alkali metal chloride, an alkaline earth metal chloride, a combination thereof, but is not limited thereto. The water/solution to be treated may include a variety of living microorganisms, anthropogenic compounds, natural compounds, or any combination thereof. The microorganism may be a bacterium, a virus, a protozoa, or others. Different kinds of microorganisms may be simultaneously present.

Chlorine and other oxidants (ozone and hydroxyl radicals) generated by the disclosed flow-through electrochemical reactors synergistically work together to purify the solution being treated.

The influent liquid may also include various anthropogenic compounds. Many of these compounds are carcinogens and are highly dangerous for human and animal health. These compounds may be efficiently oxidized to less harmful and oxidation products.

### EXAMPLES

A first reactor representative of the state-of-the-art reactor described in US Patent Publication No. 2019/0284066 and a second reactor constructed in accordance with the teachings of the instant disclosure were assembled and tested. A first set of examples (examples 1-3 below) included testing to show remediation of an environmental pollutant, in this case ammonia. A second set of examples (examples 4-6 below) included testing to show the generation of oxidants. Both the first set of examples and the second set of examples demonstrate the surprising and unexpected efficacy of the reactors and methods according to the invention particularly relative to the comparative state of the art reactor, as discussed further below.

Example 1—Two reactors were assembled. A first reactor (1a) included a cylindrical anode comprising a Magneli-phase Ti₄O₇ that was coated on an outer surface with a catalytic layer having a thickness of about 20 μm. The first reactor anode was about 19.65 inches long and had an outer diameter of about 2.33 inches. The anode was porous and hollow, but anodes may be solid or porous and hollow or non-hollow. The first reactor (1a) also included a cylindrical cathode arranged concentrically around the cylindrical anode, the cathode comprising stainless steel. The first reactor cathode was about 19.75 inches long and had an outer diameter of about 2.77 inches and an inner diameter of about 2.56 inches. The first reactor included a state of the art electroactive gap of at least 5 mm between the anode and the cathode.

A second reactor (1b) included a cylindrical anode comprising a Magneli-phase Ti₄O₇ that was coated with a catalytic layer having a thickness of about 20 μm. The second reactor anode was about 19.65 inches long and had an outer diameter of about 2.33 inches. The anode was porous and hollow, but anodes may be solid or porous and hollow or non-hollow. The second reactor (1b) also included a cylindrical cathode arranged concentrically around the cylindrical anode, the cathode comprising stainless steel. The second reactor cathode was a hollow cylinder about 19.75 inches long, having an outer diameter of 2.77 inches and an inner diameter of about 2.56 inches. The second reactor included an electroactive gap of 3 mm between the anode and cathode, according to the invention. The first reactor (1a) and the second reactor (1b) were subjected to identical test conditions as follows:

An eleven liter solution of deionized water containing 75-95 mg/L of ammonium chloride (NH₄Cl), which corresponds to 20-25 mg/L as N, 45 mg/L of sodium chloride (NaCl) and 500 mg/L of sodium sulfate (Na₂SO₄) was passed through the two reactors (1a) and (1b) at a flow rate of 3 GPM. Power was supplied to the electrodes at a voltage of 6 volts. The test conditions and results are summarized below in Table 1.

TABLE 1

| | | Flow | Sample | NaCl | Na₂SO₄ | | | | 1^{st} order |
|---|---|---|---|---|---|---|---|---|---|
| Reactor | | Rate | Volume | Dose | Dose | | | Ammonia | rate constant |
| (gap mm) | Sample | gpm | (L) | mg/L | mg/L | Time | Voltage | mg/L as N | (min⁻¹) |
| 1a (5) | NH4Cl | 3 | 11 | 45 | 500 | 0 | 0 | 23.9 | |
| | | | | | | 60 | 6 | 24 | |
| | | | | | | 120 | 6 | 17.1 | 0.0028 |
| 1b (3) | NH4Cl | 3 | 11 | 45 | 500 | 0 | 6 | 21.9 | |
| | | | | | | 60 | 6 | 14.3 | |
| | | | | | | 120 | 6 | 7.92 | 0.0085 |

As shown in the data of Table 1, the rate constant for the 3 mm electroactive gap (reactor 1b) was over 203% greater (3.03 times greater) than the rate constant for the 5 mm electroactive gap (reactor 1a). In other words, the 3 mm electroactive gap reactor (1b) cleared ammonia in the solution 3 times faster than the 5 mm electroactive gap reactor (1a) using the same amount of applied power. This result is surprising and beyond what would be expected from the efficiency increase from the drop in resistance (due to the smaller gap) alone, and even more so in view of the clogging that would have been expected.

While not being bound by theory, it is believed that the smaller electroactive gap (3 mm vs 5 mm) produces a more turbulent flow between the electrodes, which results in several advantageous flow characteristics. First, it is believed that the more turbulent flow produces a scouring action that continuously cleans the electrodes and prevents scale build up and clogging, and thereby short circuiting that would have been expected to eventually result. Second, it is believed that the turbulent flow enhances mixing, which facilitates chemical reactions that occur within the fluid itself, such as the oxidation of ammonia or other substances. Third, it is believed that the turbulent flow enhances mass transport to the electrode surfaces. This enhanced mass transport is especially advantageous when remediating perfluorinated compounds such as perfluorooctanoic acid (PFOA) and perfluorooctanesulfonic acid (PFOS), where oxidation of the perfluorinated compounds is understood to occur at the electrode surface.

Example 2—The two reactors from Example 1 were subjected to higher voltage power inputs. Otherwise, all reactor characteristics and test conditions were identical to Example 1. In Example 2, the power was supplied at 8 v. The reactor designations (1a, 1b) are also used below.

TABLE 2

| | | Flow | Sample | NaCl | Na₂SO₄ | | | | 1^{st} order |
|---|---|---|---|---|---|---|---|---|---|
| Reactor | | Rate | Volume | Dose | Dose | | | Ammonia | rate constant |
| (gap mm) | Sample | gpm | (L) | mg/L | mg/L | Time | Voltage | mg/L as N | (min⁻¹) |
| 1a (5) | NH4Cl | 3 | 11 | 45 | 500 | 0 | 0 | 21.4 | |
| | | | | | | 60 | 8 | 16.9 | |
| | | | | | | 120 | 8 | 10.5 | 0.0059 |
| 1b (3) | NH4Cl | 3 | 11 | 45 | 500 | 0 | 8 | 21.9 | |
| | | | | | | 60 | 8 | 8.83 | |
| | | | | | | 120 | 8 | 0 | 0.0151 |

As shown in the data of Table 2, the rate constant for the 3 mm electroactive gap (reactor 1b) was over 155% greater (2.55 times greater) than the rate constant for the 5 mm electroactive gap (reactor 1a). In other words, the 3 mm electroactive gap reactor 1b cleared ammonia in the solution 2.55 times faster than the 5 mm electroactive gap reactor 1a.

Example 3—The two reactors from Example 1 were subjected to higher voltage power inputs. Otherwise, all reactor characteristics and test conditions were identical to Example 1. In Example 3, the power was supplied at 12 v. The reactor designations (1a, 1b) are also used below.

TABLE 3

| | | Flow | Sample | NaCl | Na₂SO₄ | | | | 1^{st} order |
|---|---|---|---|---|---|---|---|---|---|
| Reactor | | Rate | Volume | Dose | Dose | | | Ammonia | rate constant |
| (gap mm) | Sample | gpm | (L) | mg/L | mg/L | Time | Voltage | mg/L as N | (min⁻¹) |
| 1a (5) | NH4Cl | 3 | 11 | 45 | 500 | 0 | 0 | 24.2 | |
| | | | | | | 60 | 12 | 10.7 | |
| | | | | | | 120 | 12 | 2.5 | 0.0349 |
| 1b (3) | NH4Cl | 3 | 11 | 45 | 500 | 0 | 12 | 1818 | |
| | | | | | | 53 | 12 | 2.96 | 0.0236 |

As shown in the data of Table 3, the rate constant for the 3 mm electroactive gap (reactor 1b) was over 47% greater (1.47 times greater) than the rate constant for the 5 mm electroactive gap (reactor 1a). In other words, the 3 mm electroactive gap reactor 1b cleared ammonia in the solution 1.47 times faster than the 5 mm electroactive gap reactor 1a.

Additional experiments were conducted to determine the extent of oxidant production in the reactors.

Example 4—The two reactors from Example 1 were subjected to different test parameters. The reactor designations (1a, 1b) are also used below. The two reactors 1a, 1b were subject to a flow of deionized water containing a dose of 200 mg/L of NaCl. The test was run for an eleven liter sample of water at 3 GPM. In Example 4, the power applied to the electrodes was applied at 6 V. Total oxidants were measured in the dosed deionized water. In general, the measurement of total oxidant production correlates with reactor efficiency and performance in terms of water treatment. The results are summarized below in Table 4.

TABLE 4

| | | | | | | | Total |
|---|---|---|---|---|---|---|---|
| | | Flow | Sample | NaCl | | | Oxidants |
| Reactor | | Rate | Volume | Dose | | | mg/L as |
| (gap mm) | Sample | gpm | (L) | mg/L | Time | Voltage | Cl₂ |
| 1a (5) | Water | 3 | 11 | 200 | 0 | 6 | 0 |
| | | | | | 60 | 6 | 33.8 |
| | | | | | 90 | 6 | 42.25 |
| 1b (3) | water | 3 | 11 | 200 | 0 | 6 | 0 |
| | | | | | 60 | 6 | 68.8 |
| | | | | | 90 | 6 | 76 |

As shown in the data of Table 4, the 3 mm electroactive gap (reactor 1b) produced over 79% more total oxidants than the 5 mm electroactive gap (reactor 1a). Such enhanced oxidant production is surprising and unexpected, even when accounting for the drop in resistance (due to the smaller gap), and even more so in view of the clogging that would have been expected.

Example 5—The two reactors from Example 1 were subjected to the same test parameters as described in Example 4 with the exception of voltage. The reactor designations (1a, 1b) are also used below. The two reactors 1a, 1b in test 4 were subjected to a voltage of 8 volts. The results are summarized below in Table 5.

TABLE 5

| | | | | | | | Total |
|---|---|---|---|---|---|---|---|
| | | Flow | Sample | NaCl | | | Oxidants |
| Reactor | | Rate | Volume | Dose | | | mg/L as |
| (gap mm) | Sample | gpm | (L) | mg/L | Time | Voltage | Cl₂ |
| 1a (5) | water | 3 | 11 | 200 | 0 | 0 | 0 |
| | | | | | 60 | 8 | 59.2 |
| | | | | | 90 | 8 | 68.4 |
| 1b (3) | water | 3 | 11 | 200 | 0 | 8 | 0 |
| | | | | | 60 | 8 | 107.2 |
| | | | | | 90 | 8 | 126.4 |

As shown in the data of Table 5, the 3 mm electroactive gap (reactor 1b) produced over 84% more oxidants (total oxidants) than the 5 mm electroactive gap (reactor 1a).

Example 6—The two reactors from Example 1 were subjected to the same test parameters as described in Example 4 with the exception of Voltage. The reactor designations (1a, 1b) are also used below. The two reactors 1a, 1b in test 6 were subjected to a voltage of 12 volts. The results are summarized below in Table 6.

TABLE 6

| | | | | | | | Total |
|---|---|---|---|---|---|---|---|
| | | Flow | Sample | NaCl | | | Oxidants |
| Reactor | | Rate | Volume | Dose | | | mg/L as |
| (gap mm) | Sample | gpm | (L) | mg/L | Time | Voltage | Cl₂ |
| 1a (5) | water | 3 | 11 | 200 | 0 | 0 | 0 |
| | | | | | 60 | 12 | 84 |
| | | | | | 90 | 12 | 99.2 |
| 1b (3) | water | 3 | 11 | 200 | 0 | 12 | 0 |
| | | | | | 60 | 12 | 146 |
| | | | | | 90 | 12 | 150 |

As shown in the data of Table 6, the 3 mm electroactive gap (reactor 1b) produced over 51% more oxidants (total oxidants) than the 5 mm electroactive gap (reactor 1a).

As illustrated by tests 1-6 above, the 3 mm electroactive gap produced unexpectedly superior results in every case relative to the state-of-the-art 5 mm or greater electroactive gap. The magnitude of improvement cannot be explained by a reduction in the electrical resistance alone due to the reduced space between electrodes.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A flow-through electrochemical reactor comprising:
a housing including a solution flow-path;
a flow-through or solid first electrode disposed within the solution flow-path;
a second electrode spaced apart from the flow-through or solid first electrode creating an electroactive gap between the flow-through or solid first electrode and the second electrode, the electroactive gap being less than 5 mm and greater than 2 mm.

2. The reactor of claim 1, wherein the first electrode is an anode.

3. The reactor of claim 1, wherein the second electrode is a cathode.

4. The reactor of claim 1, wherein the electroactive gap is less than about 4 mm and greater than about 2.5 mm.

5. The reactor of claim 1, wherein the electroactive gap has an average size of about 3 mm.

6. The reactor of claim 1, wherein the first electrode is an anode having a hollow cylindrical shape.

7. The reactor of claim 1, wherein the second electrode is a cathode having a hollow cylindrical shape.

8. The reactor of claim 1, wherein the first electrode has an annulus shape and the second electrode has an annulus shape, and the first electrode and the second electrode are arranged concentrically, the first electrode being located within a wall of the second electrode.

9. The reactor of claim 1, wherein a wall of the second electrode has a plurality of openings.

10. The reactor of claim 1, wherein the solution flow path extends at least partially within the first electrode, longitudinally along a longitudinal axis, and at least partially radially outward, through a wall of the first electrode, substantially perpendicular to the longitudinal axis.

11. The reactor of claim 10, wherein the solution flow path extends radially, through a wall of the first electrode, radially across the electroactive gap, and radially through a plurality of openings in the wall of the second electrode.

12. The reactor of claim 1, further comprising an electrolyte solution in the solution flow path.

13. The reactor of claim 1, further comprising a power source connected to the first electrode and to the second electrode thereby creating an electrical circuit.

14. The reactor of claim 1, further comprising an inlet cap at a first end of the housing, the inlet cap maintaining proper relative spacing and alignment of the first and second electrodes.

15. The reactor of claim 1, further comprising an outlet guide flow cap at a second end of the housing, the outlet guide flow cap sealing the second end of the housing and receiving outlet flow from the exterior of the second electrode, the outlet guide flow cap also sealing one end of the first electrode.

16. The reactor of claim 1, further comprising an adapter base inlet disposed at a first end of the housing, the adapter base providing plumbing and electrical connections while maintaining a pressure seal.

17. The reactor of claim 1, wherein the second electrode comprises one of stainless steel, graphite, or other carbonaceous materials, dimensionally stable anode (DSA), Magneli-phase titanium oxide, mixed metal oxide, or boron doped diamond (BDD).

18. The reactor of claim 1, wherein the first electrode comprises one of dimensionally stable anodes (DSA), Magneli-phase titanium oxide, mixed metal oxides, or boron doped diamond (BDD).

19. A method of electrochemically treating a solution, the method comprising:
positioning a first electrode and a second electrode less than 5 mm and greater than 2 mm apart, thereby creating an electroactive gap between the first electrode and the second electrode;
applying power to the first electrode and to the second electrode; and
passing a solution containing contaminant through the electroactive gap, electrons passing across the electroactive gap between the second electrode and the first electrode, thereby electrochemically treating the contaminants in the solution.

20. The method of claim 19, further comprising reducing contaminants on the second electrode.

21-22. (canceled)
